(19) United States
(12) Patent Application Publication
(10) Pub. No.: US 2015/0199286 A1
(43) Pub. Date: Jul. 16, 2015

(54) NETWORK INTERCONNECT WITH REDUCED CONGESTION

(71) Applicant: Samsung Electronics Co., Ltd., Suwon-si (KR)

(72) Inventors: William A. HUGHES, San Jose, CA (US); Kevin M. LEPAK, Austin, TX (US)

(73) Assignee: Samsung Electronics Co., Ltd., Suwon-si (KR)

(21) Appl. No.: 14/284,389

(22) Filed: May 21, 2014

Related U.S. Application Data
(60) Provisional application No. 61/926,249, filed on Jan. 10, 2014.

(51) Int. Cl. G06F 13/16

(52) U.S. Cl. CPC G06F 13/1673

(57) ABSTRACT

An embodiment includes a system, comprising: an interface; a buffer; and a controller configured to: receive a request through the interface; in a first mode, reserve memory in the buffer for a response to the request if the request is a first type and not reserve memory in the buffer for the response to the request if the request is a second type; and in a second mode, reserve memory in the buffer for the response to the request if the request is the first type or the second type.

### BACKGROUND

This disclosure relates to network interconnects and, in particular, network interconnects with reduced congestion.

Networks may be used to interconnect devices so that the devices may exchange data. For example, multiple processors and memory devices may exchange data through an interconnect. In a particular example, the Advanced Microcontroller Bus Architecture (AMBA) Advanced eXtensible Interface (AXI) and AXI Coherency Extensions (ACE) specifications describes techniques of exchanging data through an interconnect. However, in such interconnects, lower bandwidth devices and/or devices operating in a lower performance state may block other devices from using one or more resources of the interconnect.

### SUMMARY

An embodiment includes a system, comprising: an interface; a buffer; and a controller configured to: receive a request through the interface; in a first mode, reserve memory in the buffer for a response to the request if the request is a first type and not reserve memory in the buffer for the response to the request if the request is a second type; and in a second mode, reserve memory in the buffer for the response to the request if the request is the first type or the second type.

An embodiment includes a method, comprising: receiving a request; in a first mode, reserving memory in a buffer for a response to the request if the request is a first type and not reserving memory in the buffer for the response to the request if the request is a second type; and in a second mode, reserving memory in the buffer for the response to the request if the request is the first type or the second type.

An embodiment includes a system, comprising: a plurality of first ports, each first port including: a first interface; a second interface; a response buffer; and a controller; a plurality of second ports; a network coupled to the first ports and the second ports. For each first port, the controller is configured to: receive a request through the first interface for a response from one of the second ports; in a first mode, reserve memory in the response buffer for the response to the request if the request is a first type and not reserve memory in the response buffer for the response to the request if the request is a second type; and in a second mode, reserve memory in the response buffer for the response to the request if the request is the first type or the second type.

### BRIEF DESCRIPTION OF SEVERAL VIEWS OF THE DRAWINGS

FIG. 1 is a schematic view of a port of an interconnect operating in a first mode according to an embodiment.

FIG. 2 is a schematic view of a port of an interconnect operating in a second mode according to an embodiment.

FIG. 3 is a schematic view of a system including an interconnect according to an embodiment.

FIGS. 4-6 are signal flow diagrams illustrating effects of an interconnect operating in different modes according to some embodiments.

FIG. 7 is a schematic view of a system with an interconnect according to an embodiment.

FIG. 8 is a schematic view of an electronic system which may include an interconnect according to an embodiment.

### DETAILED DESCRIPTION

The embodiments relate to network interconnects. The following description is presented to enable one of ordinary skill in the art to make and use the embodiments and is provided in the context of a patent application and its requirements. Various modifications to the exemplary embodiments and the generic principles and features described herein will be readily apparent. The exemplary embodiments are mainly described in terms of particular methods and systems provided in particular implementations.

However, the methods and systems will operate effectively in other implementations. Phrases such as “exemplary embodiment”, “one embodiment” and “another embodiment” may refer to the same or different embodiments as well as to multiple embodiments. The embodiments will be described with respect to systems and/or devices having certain components. However, the systems and/or devices may include more or less components than those shown, and variations in the arrangement and type of the components may be made without departing from the scope of this disclosure. The exemplary embodiments will also be described in the context of particular methods having certain steps. However, the method and system operate effectively for other methods having different and/or additional steps and steps in different orders that are not inconsistent with the exemplary embodiments. Thus, embodiments are not intended to be limited to the particular embodiments shown, but are to be accorded the widest scope consistent with the principles and features described herein.

The exemplary embodiments are described in the context of particular interconnects and systems having certain components. One of ordinary skill in the art will readily recognize that embodiments are consistent with the use of interconnects and systems having other and/or additional components and/or other features. The methods and systems are also described in the context of single elements. However, one of ordinary skill in the art will readily recognize that the methods and systems are consistent with the use of interconnects and systems having multiple elements.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Furthermore, in those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

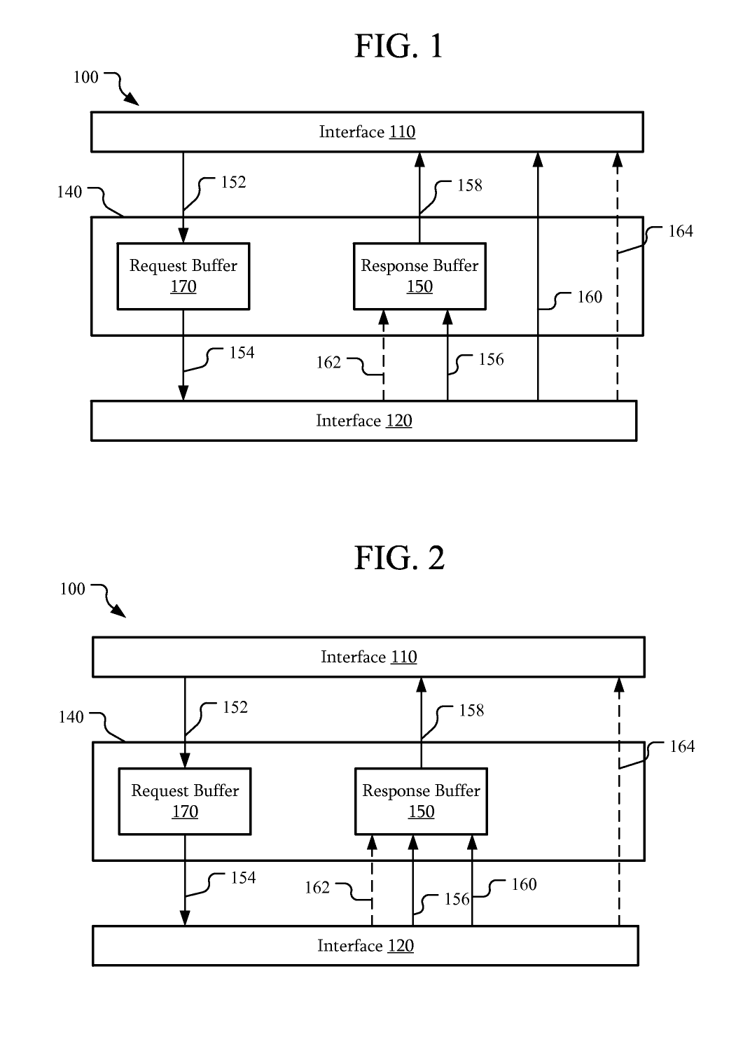

FIG. 1 is a schematic view of a port of an interconnect operating in a first mode according to an embodiment. The port 100 includes an interface 110, an interface 120, and a controller 140. The port 100 is configured to receive requests through the interface 110. For example, as will be described in further detail below, the interface 110 may be coupled to a processor, input/output (I/O) device, or the like and may be configured to receive requests for data from such devices. The interface 120 is configured to transmit the requests received through the interface 110. For example, the interface 120 may be coupled to a network.

The controller 140 is configured to control transfers between the interfaces 110 and 120, communicate to devices connected through the interfaces 110 and 120, or the like. The controller 140 may include a processor, a microcontroller, discrete logic, programmable logic devices, specific purpose integrated circuits, memory, or the like to perform various operations. In this embodiment, the controller 140 includes a request buffer 170 and a response buffer 150. Although the request buffer 170 and the response buffer 150 are illustrated as being part of the controller 140, the request buffer 170, the response buffer 150, and other components may be separate from other devices of the controller 140; however, the controller 140 may still be configured to perform the operations described herein.

In an embodiment, the controller 140 may be configured to receive an incoming request 152 and store the requests in the request buffer 170. The controller 140 may be configured to forward a request 154 through the interface 120. Although entire requests 152 may be buffered in the request buffer 170, in other embodiments, requests 154 may be stored in different manners. For example, once a request is transmitted, a reduced set of information sufficient to identify a response to the request may be stored in the request buffer 170, a different buffer, or the like.

The controller 140 may be configured to receive a response 156 through the interface 120. The controller 140 may be configured to store the response 156 in the response buffer 150. For example, a particular set of requests transmitted through the interface 120 may be for ordered responses. However, the responses may return out of order. The response buffer 150 may be used to store the responses 156 until all responses to the requests of the set are received. Then the ordered responses may be transmitted through the interface 110 as responses 158. In operation, not all responses need to be stored in the response buffer 150. For example, the controller 140 may be configured to forward some responses 160 from the interface 120 to the interface 110 without buffering.

In an embodiment, the controller 140 may be configured to operate in multiple modes. In a first mode, the controller 140 may be configured to receive a request 152 through the interface 110. The controller 140 may be configured to reserve memory in the response buffer 150 for a response to the request if the request 152 is of a first type, and not to reserve memory in the response buffer 150 for the response to the request 152 if the request is of a second type.

In an embodiment, the requests of a first type may be ordered requests. For example, as described above, a set of requests may request ordered responses to the requests of the set. In a particular example, each request of the set of requests may have the same identifier, such as an AXI ID transaction identifier. Requests of the second type may be requests which do not request ordered responses. For example, the requests of the second type may be requests with identifiers that are different, unique, substantially unique, or the like. In another example, the requests of the second type may be requests having responses that do not depend on other responses and may be forwarded from the interface 120 to the interface 110 as response 160 without being buffered in the response buffer 150, such as responses to orderless requests. Although an identifier has been used as an example of a parameter to identify whether a request is part of a set of requests requesting an ordered response, in other embodiments, different parameters may indicate that a request is part of such a set. For example, a flag may be set in the controller 140 before a request is transmitted, a separate field in the request may indicate that the request is part of a set, or the like.

In a particular embodiment, in the first mode, the controller 140 may be configured to reserve memory in the response buffer 150 for the response to the request for less than all request types. In the example above, only two different types are described. Thus, less than all of the requests may include only requests of the first type and not requests of the second type. However, in other embodiments, additional types of requests may be received. Here, additional responses 162 and 164 are illustrated as dashed lines indicating responses to requests of types different from the first and second types that may be present. The controller 140 may be configured to reserve memory in the response buffer 150 for the response 162, but not the response 164. Accordingly, the controller 140 is configured to store the responses 162 in the response buffer 150 and forward the responses 164 through the interface 110.

FIG. 2 is a schematic view of a port of an interconnect operating in a second mode according to an embodiment. In this embodiment, the port 100 of FIG. 1 is illustrated; however, the controller 140 is configured to operate in a second mode. In the second mode, the controller 140 is configured to reserve memory in the response buffer 150 for the response to the request if the request is the first type or the second type. That is, while responses 156 associated with requests of the first type may again be stored in reserved memory in the response buffer 150, responses 160 associated with requests of the second type may also be stored in reserved memory in the response buffer 150.

Again, responses 162 and 164 associated with requests of other types may be processed in the second mode as in the first mode. However, in the second mode, for at least one of the types of requests for which memory was not reserved in the response buffer 150 in the first mode, the controller 140 is now configured to reserve memory in the response buffer 150. That is, in the first mode, memory was reserved in the response buffer 150 for request types associated with responses 156 and 162 while memory was not reserved in the response buffer 150 for request types associated with responses 160 and 164. In the second mode, memory is reserved in the response buffer 150 as in the first mode; however, memory is now reserved for request types associated with response 160. In another particular embodiment, in the second mode, the controller 140 may be configured to reserve memory in the response buffer 150 for responses to all requests.

In an embodiment, the controller 140 may be configured to reject a request if memory in the response buffer 150 for a response to the request is to be reserved, but is not available. Accordingly, a flow of requests passing out the interface 120 may be throttled and, in particular, the types of requests that are subject to such throttling may change depending on the operational mode of the controller 140. For example, in the first mode, the controller 140 is configured to reserve memory in the response buffer 150 for requests of the first type. Accordingly, such requests may be rejected if memory is not available in the response buffer. However, for requests of the second type, the controller 140 is not configured to reserve memory in the response buffer 150 for responses to those requests. Thus, requests of the second type need not be rejected. The requests of the second type may be rejected for other reasons, such as insufficient space in the request buffer 170; however, the requests are not rejected because memory is not available in the response buffer 150.

In contrast, in the second mode, the controller 140 is configured to reserve memory in the response buffer 150 for requests of the second type. If the memory is not available, the request may be rejected. Thus, requests of the second type that were previously accepted and forwarded through the interface 120 in the first mode may now be rejected because of a lack of memory in the response buffer 150. In other words, more types of requests may now be throttled due to available space in the response buffer 150. In particular, if in the second mode, the controller 140 is configured to reserve space in the response buffer 150 for all types of requests, all types of requests may be throttled.

Although rejecting a request is used as an example of an operation when memory is not available in the response buffer 150, other operations may be performed. For example, such a request may be stored in a different buffer, the request may be stored in the request buffer 170 but not forwarded through the interface 120, or the like to await available memory in the response buffer. Accordingly all such requests that may be rejected may, but need not be rejected immediately.

In an embodiment, a number of entries in the request buffer 170 may be larger than a number of entries in the response buffer 150. However, the size of the request buffer 170 may be smaller than a size of the response buffer 150. For example, an entry in the request buffer 170 may be about 20 bits while an entry in the response buffer 150 may be about 64 bytes; however, the request buffer 170 may be configured to store about 40 entries while the response buffer 150 is configured to store about 8 entries. As a result, about 40 outstanding requests may be stored in the request buffer 170; however, only about 8 of those may be requests for which memory is reserved in the response buffer 150.

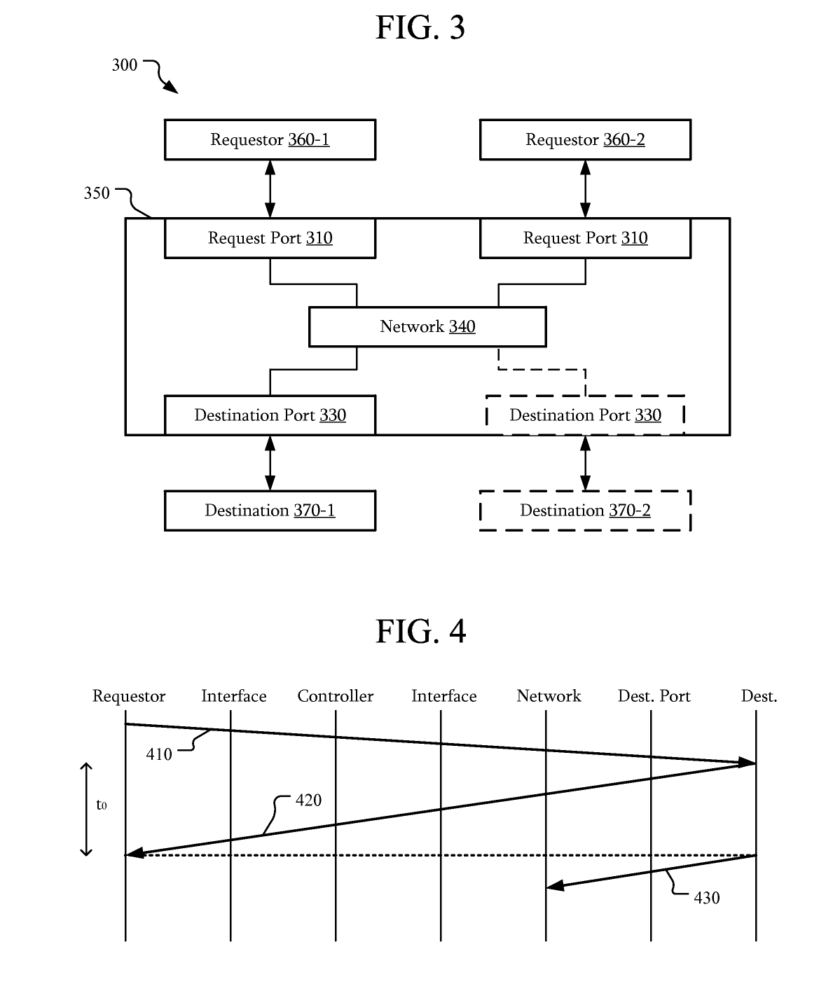

FIG. 3 is a schematic view of a system including an interconnect according to an embodiment. In this embodiment, the system 300 includes an interconnect 350, requestors 360, and at least one destination 370. The interconnect 350 includes request ports 310, at least one destination port 330, and a network 340. The request ports 310 may be a port as described herein; however, in other embodiments, all request ports 310 of the interconnect 350 may, but need not be a port as described herein.

The network 340 is configured to couple the request ports 310 to at least one destination port 330. In an embodiment, the network 340 may be configured to couple multiple request ports 310 to a single destination port 330; however, in other embodiments, the network 340 may be configured to couple multiple request ports 310 to multiple destination ports 330.

Each requestor 360 is coupled to a corresponding request port 310. The requestors 360 are configured to generate requests that are transmitted to the request ports 310 to be forwarded on to a destination 370. The destination 370 is configured to receive the request and, if capable, transmit a response to the request through the interconnect 350 to the requestor 360. As will be described in further detail below, a destination 370 may be a memory device, a memory controller, or the like. Accordingly, the request may be, for example, a request for data and the response may be the requested data. However, in other embodiments, the destination 370 may be any device capable of responding to a request for data. For example, the destination 370 may be a register or registers, an input/output device, an input/output fabric coupled to multiple input/output devices, or the like.

In an embodiment, a requestor 360-1 may be using a larger portion of the bandwidth of the interconnect 350. In particular, a response to a request from the requestor 360-1 may block at least part of the network 340. In a particular embodiment, if the requestor 360-1 is operating in a higher performance state, the transmission of a response from the destination 370 to the requestor 360-1 may not block the network 340. However, the requestor 360-1 may be operating in a lower performance state. Accordingly, even though the destination 370 may be capable of transmitting a response at a higher speed to the requestor 360-1, the transmission may be slower due to the lower performance state of the requestor 360-1.

Referring to FIGS. 1-3, in an embodiment, the controller 140 may be configured to determine a performance state. In particular, the performance state may be the performance state of a requestor 360 coupled to the corresponding request port 310. The controller 140 may be configured to select between the first mode and the second mode in response to the performance state.

For example, the controller 140 may be configured to select the first mode if the performance state indicates a higher performance and select the second mode if the performance state indicates a lower performance. As described above, for more request types, if not all request types, the controller 140 is configured to reserve memory for the responses to more request types in the second mode than in the first mode. Accordingly, when the requestor 360-1 is operating with lower performance, as indicated by the lower performance state, the controller 140 is configured to operate in the second mode and hence, the controller 140 will attempt to reserve memory in the response buffer 150 for more if not all of the requests. As a result, a number of outstanding requests and the corresponding responses may be throttled.

In an embodiment, reserving memory for more requests may move the point at which the transmission of a response stalls. FIGS. 4-6 are signal flow diagrams illustrating effects of an interconnect operating in different modes according to some embodiments. In particular, FIGS. 4-6 illustrate differences due to reserving memory in the response buffer 150. Referring to FIGS. 1, 3, and 4, a requestor 360-1 may transmit a request 410 that is transmitted to the destination 370. When the destination 370 transmits the response 420 to the requestor 360-1 and the requestor 360-1 is operating in the lower performance state, the time t₀ taken to transmit the response 420 may be relatively long. As a result, access to the network 340 and responses from the destination 370 may be blocked. Thus, the requestor 360-2 may be blocked from receiving a response 430 from the destination 370-1 or another destination 370-2 until the time t₀ passes.

Referring to FIGS. 1, 3, and 5, if the controller 140 is operating in the second mode, for a request 510 of the second type, the controller 140 attempts to reserve memory in the response buffer 150. However, in this example, memory is not available. Accordingly, the request 510 is rejected as indicated by rejection 520. A response 530 to a request from requestor 360-2 may proceed as resources of the network 340 are not blocked.

Referring to FIGS. 1, 3, and 6, the controller 140 is again operating in the second mode and, for a request 610 of the second type, the controller 140 attempts to reserve memory in the response buffer 150. Here, the reservation is successful and the request is transmitted on to the destination 370. The response 620 is again transmitted towards the requestor 360-1. However, because memory was reserved in the response buffer 150 before transmitting the request 610, the response 620 may be stored in the response buffer 150 after time t₁ passes, allowing the destination 370 and network 340 to perform transactions. Thus, even though transmitting the response 620 to the requestor 360 as response 630 may take a longer time t₂, that delay no longer blocks the network 340 and destination 370. A response 640 to a request from requestor 360-2 may proceed after time t₁ passes as resources of the network 340 are not blocked.

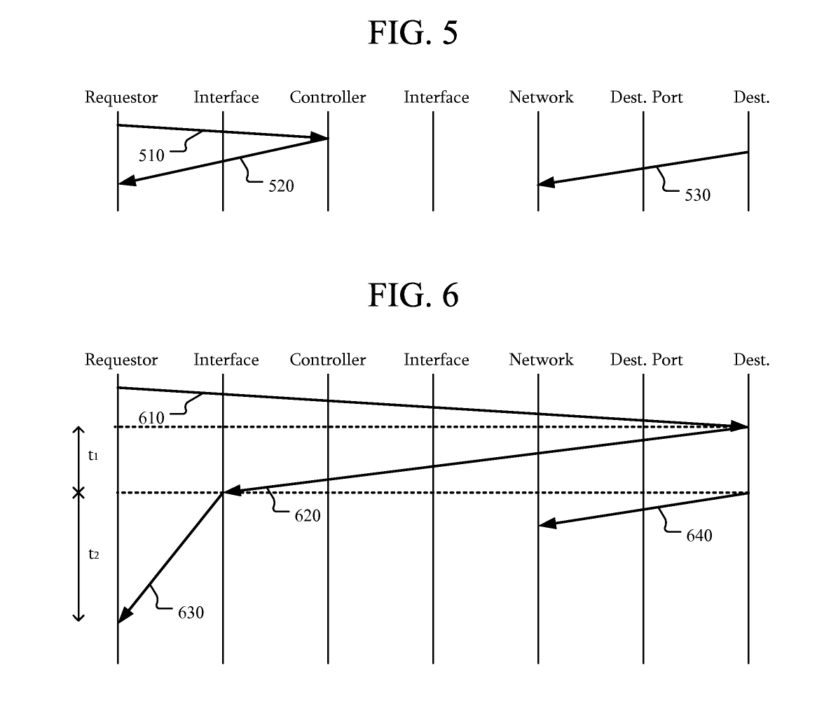

In FIGS. 4-6, responses to a request from requestor 360-2 are illustrated as terminating at the network 340 because those responses are transmitted to a different requestor than illustrated. In addition, such responses may not be transmitted from the same destination illustrated in FIGS. 4-6, but may also use the same resources of the network 340. Consequently, the responses may be similarly blocked as in FIG. 4 and transmitted as in FIGS. 5 and 6.

Referring to FIGS. 1 and 3, in an embodiment, the controller 140 may be configured to receive a performance state through either or both the interface 110 or the interface 120. For example, a requestor 360 may transmit a message to the request port 310, set a flag or other state in the request port 310, or the like to indicate the performance state. In a particular example, the requestor 360 may transmit a signal indicating that the requestor 360 is in a lower performance mode or a higher performance mode.

However, in another embodiment, the controller 140 may be configured to determine a performance state. For example, the controller 140 may be configured to monitor signals received from a requestor 360. In a particular example, the controller 140 may determine how long the requestor 360 takes to assert a ready signal indicating that it is ready for data after the request port 310 indicates that data is valid.

In another embodiment, the controller 140 may determine the performance state in response to the network 340. For example, the network may be configured to monitor traffic passing through the network 340, identities of requestors, identities of destinations, or the like. This information may be used to send a message to a request port 310 and in response, the controller 140 may change modes accordingly. For example, the network 340 may be configured to determine if a particular requestor is using an amount of bandwidth, using more bandwidth than other requestors, blocking one or more destinations, using resources of the network 340 that may reduce performance, or the like. The network 340 may be configured to send the message to the particular requestor to cause the controller 140 to operate in the second mode. Accordingly, less requests will be forwarded by that requestor through the network 340 and/or responses will be buffered in reserved memory of the response buffer 150 and hence, not block portions of the network 340.

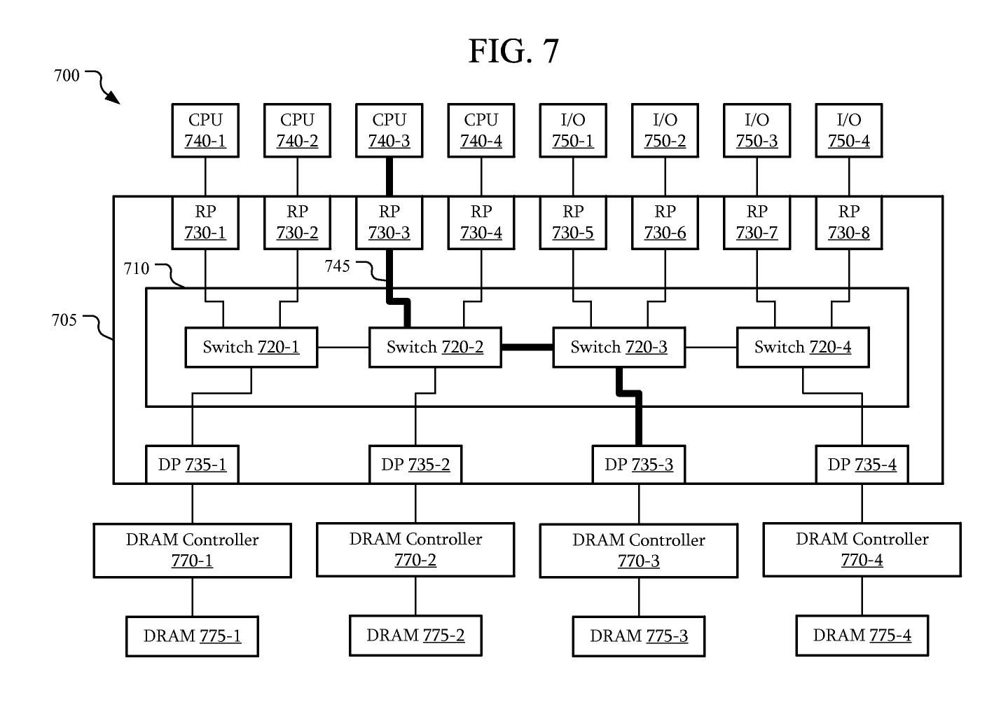

FIG. 7 is a schematic view of a system with an interconnect according to an embodiment. Referring to FIGS. 1 and 7, in this embodiment, the system 700 includes an interconnect 705. The interconnect 705 includes multiple request ports 730 coupled to multiple CPUs 740 and I/Os 750. Here, the CPUs 740 and I/Os 750 are used as examples of requestors. The requestors that are coupled to the request ports 730 may be any device that may issue requests to a destination through a network. For example, the requestors may be a processor such as a central processing unit (CPU), a graphics processing unit (GPU), or the like, a video device, an audio device, a network device, or the like.

The destination ports 735 may be cache coherence managers (CCM). The CCMs may be configured to make sure all requests are coherent. For example, a CCM may receive a request from a CPU 740 for a read of the DRAM 775. The CCM may issue a snoop to see if data satisfying the request is cached in another CPU 740 cache and thus, the DRAM may be stale.

The destination ports 735 are each coupled to a DRAM controller 770, each of which are coupled to a corresponding DRAM 775. Although illustrated as distinct, the DRAMs 775 may be different DRAM channels, the same physical device, or the like.

In a particular example, the interconnect 705 may be a coherent interconnect coupling multiple CPUs to a DRAM cluster. The CPUs may be ARM CPUs that share an L2 cache. Although 4 CPUs are illustrated, any number of CPUs may be present. For example, from 1-8 CPUs or more may be coupled to the interconnect 705.

The request ports 730 may be any request port as described herein. In particular, the request ports 730 may have controllers and response buffers as described herein.

In this embodiment, the network 710 includes multiple switches 720. Each of the request ports 730 and destination ports 735 are coupled to the switches 720. The switches 720 form a routing fabric through which requests and responses are routed between request ports 730 and destination ports 735.

In an embodiment, the interconnect 705 may provide an interface at the request ports 730 and destination ports 735 that implements the AMBA AXI and/or ACE specifications.

A request may be sent having an ID, such as an AXI ID transaction identifier. The IDs from a requestor may be different; however, multiple requests with the same ID may be issued. These multiple requests may represent an ordered set of requests. In response, an ordered set of responses is expected from the interconnect 705.

If requests are sent to only one destination, the destination may return the responses to the requests in order. However, with multiple destinations, the responses may return out of order. A reorder buffer, such as the response buffer 150 in a request port 730, may be used to reorder out-of-order responses. The controller 140 may be configured to record the order of requests or otherwise maintain information to transmit ordered responses to the requestor. In particular, the responses are buffered in the response buffer 150 as the requests return so that the responses may be returned in order. If memory in the response buffer is not available for the responses, the requests are not issued.

In a particular embodiment, requests with the same ID may occur less frequently than requests with unique IDs. Accordingly, the response buffer 150 need not include sufficient space to store responses to all outstanding requests. For example, if 30 requests may be outstanding, the response buffer 150 need not include memory for 30 responses. In particular, because of the lower likelihood of requests with matching IDs, less memory may be used.

However, a requester, such as a CPU 740-3 may be operating at a lower frequency. For example, the CPU 740-3 may enter a low power state and change from an operating frequency of about 3 GHz to about 200 MHz. Although particular frequencies are given as examples, the frequencies at higher or lower performance states may be different.

Because of the lower operating frequency of CPU 740-3, CPU 740-3 will receive responses at a slower rate. Path 745, illustrated with bold lines, represents the path of data from the destination port 735-3 to the CPU 740-3. Resources along the path 745 will be occupied while the response is being transferred. In particular, portions of switches 720-2 and 720-3 and the connection between switches 720-2 and 720-3 may be unavailable for other requests or responses. For example, a response involving CPU 740-4 and DRAM 775-4 must wait until the response along path 745 is complete as such response involving CPU 740-4 and DRAM 775-4 would use the connection between switches 720-2 and 720-3.

If CPU 740-3 is operating in a higher performance state, resources along path 745 will be occupied for a relatively short amount of time. That is, the amount of time the resources are occupied may be an acceptable delay for another request or response. However, if the CPU 740-3 is operating in a lower performance state, the resources along path 745 may be occupied for a relatively long amount of time.

As described above, in such a situation where CPU 740-3 is operating in a lower performance state, the controller 140 of request port 730-3 may operate in the second mode and consequently, attempt to reserve memory in the response buffer 150 for responses to more requests or all requests. If memory is not available, then the controller 140 will not issue the request. Thus, the blockage due to path 745 will not occur. If memory is available and is reserved, the response travelling along path 745 may be transmitted at a higher speed as even though the CPU 740-3 is operating in a lower performance state, the response buffer 150 in the request port 730-3 is not operating in a lower performance state. Thus, the response may be transmitted through the path 745 as if the CPU 740-3 was operating in a higher performance state. As a result, the time that resources along path 745 are occupied may be similar to the state when CPU 740-3 is operating in the higher performance state even though the CPU 740-3 may be operating in a lower performance state.

In a particular example, the various components of the interconnect 705 and connected devices may communicate using a handshake protocol such as ready/valid signals. Using ready/valid signals as an example, when the destination port 735-3 is ready to transmit a response to CPU 740-3, the destination port 735-3 may assert a valid signal for the switch 720-3. In response, the switch 720-3 may assert a valid signal for the switch 720-2. Similarly, signals are asserted along the path 745 and then to CPU 740-3.

However, the CPU 740-3 may not be ready for the data. The CPU 740-3 may assert a not-ready signal, not assert the ready signal, or the like indicating that it is not ready for the data. That signal may propagate back along the path 745. Thus, the transfer of the response may stall until the CPU 740-3 can assert a ready signal. In contrast, if the controller 140 of the response port 730-3 is operating in the second mode for the type of the response from the destination port 735-3, the requestor port 730-3 may assert a ready signal, allowing the response to be transmitted to the requestor port 730-3 even if the CPU 740-3 has not asserted the ready signal, is receiving data slowly, or the like.

In an embodiment, other elements of the interconnect 705 may have buffers configured to store responses to requests. However, one or more of these buffers may be relatively small. That is, the buffers are not sized to accommodate all or most traffic in operation. In particular, the smaller buffers may push the decision whether to issue a request to a point outside of the network 710, allowing network 710 resources to be used more efficiently. In a particular embodiment, a size of a buffer within the interconnect 705 may be smaller than a size of a response buffer 150 of a request port 730 of the interconnect.

Although the response buffer 150 has been used as an example of a buffer where memory may be reserved for responses, the buffer may be located in different and/or multiple locations. For example, the response buffer 150 may be located in a switch 720, a destination port 735, or the like. The controller 140 may still be configured to reserve memory in such buffers. Accordingly, response paths from a destination to the device with the response buffer 150 may be blocked less frequently.

An embodiment includes a system with integrated circuit cache designs. The system may include interconnect networks which connect multiple requestors, such as blocks which generate read/write requests to one or more request destinations such as system memory, RAM, registers, I/O devices, or the like. A bandwidth mismatch may exist between the interconnect and one or more requestors. This may cause interconnect congestion that may block traffic to other requestors.

In an embodiment, a reorder buffer structure may address ordering issues to resolve interconnect network traffic congestion issues resulting from requestor/interconnect bandwidth mismatches. Requestors ordinarily use the reorder buffer for requests with ordering constraints. When low requestor bandwidth conditions exist the interconnect request port may switch to a mode where the reorder buffer is used for all read requests. The reorder buffer may then be used as a staging buffer to offload responses from the interconnect and thereby reduce if not avoid congestion problems.

In some interconnect architectures such as those compliant with ARM's AMBA ACE/AXI bus protocol, some read requests may have ordering constraints such that the read responses must be returned to the requestor in the same order as the requests were received by the interconnect. In complex interconnects with multiple memory or I/O targets, read responses may be returned out of order from the different targets. As a result a reorder buffer may be built at the interconnect ingress point for each requestor in order to store the read response data which is returned out of order, thereby allowing it to be held until older read responses are returned and hence allowing the read responses to ultimately be returned in order to the requestor.

Interconnect requirements have become complex with many request sources and destinations each with different characteristics. An interconnect architecture suitable to address such requirements may involve arranging a number of request ports and destination ports around a network of switches which route traffic between the request and destination ports. Since the switches route traffic to/from multiple requestors/destinations, traffic paths through any particular switch may be shared such that if read response traffic flow to a particular requestor is blocked for some reason, the path which such traffic takes from destination port through the switch network to the requestor becomes blocked, and any traffic between other requestor/destination pairs which happens to share a portion of the blocked routing path will itself be blocked. In some interconnect architectures, there is a significant effort invested to reduce the complexity, area, and power of the routing blocks and switching blocks in various ways, for example, by removing buffering within the network itself as much as possible. In these emerging architectures, the potential impact of any blockage at an endpoint is more significant since the network's internal ability to absorb an endpoint blockage is reduced, and therefore methods of handling endpoint congestion have increased value and interest.

Such traffic congestion may occur when a requestor's interface to the interconnect is mismatched from a bandwidth perspective such that it accepts read response data at a slower rate than the interconnect is capable of delivering it. This may occur due to the design constraints of the requestor which result in a block which is less capable from a bandwidth perspective. It could also occur dynamically due to a particular requestor entering a lower power state where it's frequency (and hence bandwidth capabilities) are reduced to save power. Note that for high bandwidth requesters (such as CPUs or CPUs), such requestors may support unordered responses.

In an embodiment, the traffic congestion problems due to the bandwidth mismatch may be alleviated or resolved by leveraging the re-order buffer. When a requestor's receive bandwidth capability is reduced to a level such that it may cause an interconnect congestion problem, the interconnect switches to a mode whereby a read data re-order buffer entry is reserved before a read request from the slow requestor is issued from the request port to the target. This is the same constraint which must be applied for ordered requests, but here the constraint is applied for all read requests from the slow requestor irrespective of ordering requirements. As a result when read response traffic is returned through the interconnect to the slow requestor port, the data is written at full interconnect bandwidth into the read re-order buffer, thereby reducing congestion problems. The data is then read from the read re-order buffer at a slower rate matching the lower requestor bandwidth. Note that in many cases, the high bandwidth requesters naturally support unordered responses for most of their requests. Therefore, the re-order buffer may be sized to the subset of low bandwidth ordered traffic requirements in common cases, which may be smaller. The dynamic ability to switch between non-usage (high performance/bandwidth endpoint mode) and usage (low performance/bandwidth endpoint mode) of the re-order buffer allows for the common case high-performance to be handled with minimal resources (re-order buffer lightly used) and the re-order buffer only sized for low performance cases, saving valuable area and power from naively sizing the re-order buffer to cover the high bandwidth unordered requestor case.

The description above uses ARM's ACE/AXI bus protocol as an example of a protocol which requires a read re-order buffer. Other bus protocols may exist which have similar requirements resulting in the need for a reorder buffer.

In an embodiment, the existence of the reorder buffer may be to provide a buffer for staging the read response data. An interconnect network with no reorder buffer requirements could nevertheless provide a staging buffer in order to offload the network.

In an embodiment, read response data may be offloaded at a requestor interface. Offload buffering may be provided for other types of traffic at other locations in the network.

In an embodiment, in a first mode, a read data buffer (RDB) entry is reserved prior to issuing reads only for ordered reads. As a result, the RDB may be small. Slow requestors (e.g. CPUs in low dynamic voltage frequency scaling (DVFS) state) may reserve read data buffer entries prior to issuing all reads. Here, a small RDB may still be acceptable because the requestor is operating in a low bandwidth state. Read data transmitted through the interconnect may be stored at full bandwidth into the RDB. The RDB is emptied at bandwidth throttled by the slow requestor. This offloading reduces congestion on the interconnect.

A particular embodiment includes two modes. In a first mode, memory in the RDB is reserved only for ordered requests. This may result in a high bandwidth for most reads with a small RDB. In a second mode, memory in the RDB is reserved for all reads. This may result in a low bandwidth with a small RDB but, since the CPU is in a low DVFS state, the small RDB is still acceptable. The system may operate in the second mode when hardware detects that the requestor is running slowly.

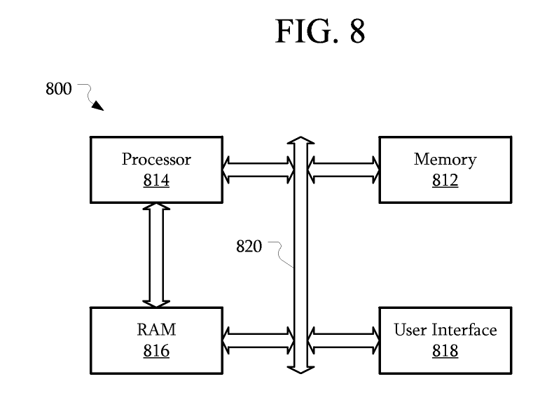

FIG. 8 is a schematic view of an electronic system which may include an interconnect according to an embodiment. The electronic system 800 may be part of a wide variety of electronic devices including, but not limited to portable notebook computers, Ultra-Mobile PCs (UMPC), Tablet PCs, servers, workstations, mobile telecommunication devices, and so on. For example, the electronic system 800 may include a memory system 812, a processor 814, RAM 816, and a user interface 818, which may execute data communication using a bus 820.

The processor 814 may be a microprocessor or a mobile processor (AP). The processor 814 may have a processor core (not illustrated) that can include a floating point unit (FPU), an arithmetic logic unit (ALU), a graphics processing unit (GPU), and a digital signal processing core (DSP Core), or any combinations thereof. The processor 814 may execute the program and control the electronic system 800. The processor 814 may include multiple processor cores coupled to an interconnect as described herein.

The RAM 816 may be used as an operation memory of the processor 814. Alternatively, the processor 814 and the RAM 816 may be packaged in a single package body.

The user interface 818 may be used in inputting/outputting data to/from the electronic system 800. The memory system 812 may store codes for operating the processor 814, data processed by the processor 814, or externally input data. The memory system 812 may include a controller and a memory. The memory system may include an interface to computer readable media. Such computer readable media may store instructions to perform the variety of operations describe above.

Although the structures, methods, and systems have been described in accordance with exemplary embodiments, one of ordinary skill in the art will readily recognize that many variations to the disclosed embodiments are possible, and any variations should therefore be considered to be within the spirit and scope of the apparatus, method, and system disclosed herein. Accordingly, many modifications may be made by one of ordinary skill in the art without departing from the spirit and scope of the appended claims.

1. A system, comprising:
an interface;
a buffer; and
a controller configured to:
receive a request through the interface;
in a first mode, reserve memory in the buffer for a response to the request if the request is a first type and not reserve memory in the buffer for the response to the request if the request is a second type; and
in a second mode, reserve memory in the buffer for the response to the request if the request is the first type or the second type.

2. The system of claim 1, wherein:
the first type includes requests with identical identifiers; and
the second type includes requests with different identifiers.

3. The system of claim 1, wherein:
the first type includes requests associated with requests of an ordered set; and
the second type includes orderless requests.

4. The system of claim 1, wherein the controller is further configured to:
in the first mode, reserve memory in the buffer for the response to the request for less than all request types; and
in the second mode, reserve memory in the buffer for responses to all requests.

5. The system of claim 1, wherein the controller is further configured to:
determine a performance state; and
select between the first mode and the second mode in response to the performance state.

6. The system of claim 5, wherein:
the controller is further configured to receive the performance state through the interface; and
the performance state indicates a performance state of a requestor associated with the request.

7. The system of claim 1, wherein the controller is further configured to:
receive a performance state signal through the interface;
operate in the first mode if the performance state signal indicates a first performance state; and
operate in the second mode if the performance state signal indicates a second performance state;
wherein the first performance state indicates a higher performance than the second performance state.

8. The system of claim 1, the interface referred to as a first interface, the system further comprising:
a second interface;
wherein the controller is further configured to:
receive a performance state signal from a network through the second interface; and
select from among the first mode and the second mode in response to the performance state.

9. The system of claim 1, the interface referred to as a first interface, the system further comprising:
an network including a network buffer;
a second interface coupled to the network;
wherein:
the controller is further configured to transmit the request to the network through the second interface; and
a size of the network buffer is smaller than a size of the buffer.

10. The system of claim 1, further comprising:
a request buffer configured to store entries associated with requests;
wherein a maximum number of entries of the request buffer is larger than a maximum number of entries of the buffer.

11. The system of claim 1, wherein the controller is further configured to reject the request if memory in the buffer for the response to the request is not available.

12. The system of claim 1, wherein the controller is further configured to, if memory in the buffer for the response to the request is not available, transmit the request after memory in the buffer for the response to the request is available.

13. A method, comprising:
receiving a request;
in a first mode, reserving memory in a buffer for a response to the request if the request is a first type and not reserving memory in the buffer for the response to the request if the request is a second type; and
in a second mode, reserving memory in the buffer for the response to the request if the request is the first type or the second type.

14. The method of claim 13, wherein:
the first type includes requests associated with requests of an ordered set; and
the second type includes orderless requests.

15. The method of claim 13, further comprising:
in the first mode, reserving memory in the buffer for the response to the request for less than all request types; and
in the second mode, reserving memory in the buffer for responses to all requests.

16. The method of claim 13, further comprising:
determining a performance state; and
selecting between the first mode and the second mode in response to the performance state.

17. The method of claim 16, wherein:
receiving the request comprises receiving the request through an interface;
the performance state indicates a performance state of a requestor associated with the request; and
further comprising receiving the performance state through the interface.

18. The method of claim 13, further comprising:
receiving a performance state signal;
operating in the first mode if the performance state signal indicates a first performance state; and
operating in the second mode if the performance state signal indicates a second performance state;
wherein the first performance state indicates a higher performance than the second performance state.

19. The method of claim 13, wherein:
receiving the request comprises receiving the request through a first interface; and
further comprising:
receiving a performance state signal from a network through a second interface; and
selecting from among the first mode and the second mode in response to the performance state.

20. A system, comprising:
a plurality of first ports, each first port including:
a first interface;
a second interface;
a response buffer; and
a controller;
a plurality of second ports;
a network coupled to the first ports and the second ports;
wherein for each first port, the controller is configured to:
receive a request through the first interface for a response from one of the second ports;
in a first mode, reserve memory in the response buffer for the response to the request if the request is a first type and not reserve memory in the response buffer for the response to the request if the request is a second type; and
in a second mode, reserve memory in the response buffer for the response to the request if the request is the first type or the second type.
